(19) United States
(12) Patent Application Publication
(10) Pub. No.: US 2012/0320404 A1
(43) Pub. Date: Dec. 20, 2012

(54) DISPLAYING PRINTER STATUS DURING POWER-OFF USING BISTABLE DISPLAY

(75) Inventor: Asad Khalid Raja, Bristol (GB)

(73) Assignee: XEROX CORPORTATION, Norwalk, CT (US)

(21) Appl. No.: 13/159,794

(22) Filed: Jun. 14, 2011

(51) Int. Cl. G06F 3/12

(52) U.S. Cl. 358/1.15

(57) ABSTRACT

Methods and structures respond to activation of a switch (or other similar user input) of a printing apparatus that controls whether a power supply is connected to and supplies power to a processor, a printing engine, and a graphic user interface of the printing apparatus. The graphic user interface comprises a bistable display that continues to show the most recently provided screenshot after the switch disconnects the power supply from the graphic user interface. Further, methods and structures cause, using the processor, the graphic user interface to display status information of the printing apparatus immediately prior to the switch being allowed to disconnect the power supply from the graphic user interface such that the graphic user interface displays the status information after being disconnected from the power supply. Thus, the methods and structures delay, using the processor, disconnection of the power supply from the graphic user interface until the status information is displayed on the graphic user interface.

### BACKGROUND

Embodiments herein generally relate to printer devices and more particularly to displaying the status of a printer apparatus during periods when the power supply is off using a bistable display that does not require power to maintain a screenshot.

Conventional graphic user displays, such as liquid crystal displays (LCD) rely on emitted light, such as a backlight, that requires constant power to be observable. Thus, existing graphic user displays used by printing devices consume watts of power. Liquid crystal displays need a constant backlight, and constantly consume power.

### SUMMARY

In view of the foregoing, the embodiments herein sense activation of a switch (or other similar user input) of a printing apparatus that controls whether a power supply is connected to and supplies power to a processor, a printing engine, and a graphic user interface of the printing apparatus. The graphic user interface comprises a bistable display that continues to show the most recently provided screenshot, even after the switch disconnects the power supply from the graphic user interface. Further, embodiments herein cause the graphic user interface to display status information of the printing apparatus immediately prior to the switch being allowed to disconnect the power supply from the graphic user interface, such that the graphic user interface displays the status information after being disconnected from the power supply. Thus, the embodiments herein delay, using the processor, disconnection of the power supply from the graphic user interface until the status information is displayed on the graphic user interface.

Therefore, various embodiments herein comprise different forms of a printing apparatus that include at least one power supply operatively connected to (directly or indirectly connected to) a processor, a printing engine, and a graphic user interface. Further, the power supply includes a switch that controls whether the power supply is connected to and supplies power to the processor, the printing engine, and the graphic user interface. The graphic user interface comprises a bistable display that continues to show the most recently provided screenshot after the switch disconnects the power supply from the graphic user interface. The processor controls responses to user input to the switch, and the processor causes the graphic user interface to display status information of the printing apparatus immediately prior to disconnecting the power supply from the graphic user interface in response to the user input to the switch, such that the graphic user interface displays the status information after being disconnected from the power supply. Thus, the processor delays disconnection of the power supply from the graphic user interface until the status information is displayed on the graphic user interface.

Alternatively, instead of delaying disconnection of the power supply, the processor can engage an auxiliary power supply to cause the graphic user interface to display status information of the printing apparatus immediately after the switch disconnects the power supply from the graphic user interface, such that the graphic user interface will display the status information after being disconnected from the power supply. Afterword, the processor disengages the auxiliary power supply once the graphic user interface displays the status information.

The status information comprises, for example, consumable supply levels, printer operational status, and/or warning messages. In addition, the body of the printing apparatus surrounds the processor, the printing engine, and power supply. The body has at least one curved section, and the graphic user interface comprises a curved graphic user interface that conforms to the shape of the curved section of the body. The bistable display can be, for example, an electrophoretic display, a bichromal balls display, etc.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flowchart illustrating an embodiments herein;

FIG. 2 is a flowchart illustrating an embodiments herein;

FIG. 3 is a side-view schematic diagram of a device according to embodiments herein; and

FIG. 4 is a side-view schematic diagram of a device according to embodiments herein.

### DETAILED DESCRIPTION

As mentioned above, existing liquid crystal displays need a constant backlight, and consume power all the time. Electrophoretic displays or “E-ink” displays differ from their LCD counterparts in that they rely on reflected light, whereas LCD's rely on emitted light. Thus, LCD's are bound by their requirement of a backlight and, as such, require constant power. Furthermore, E-ink displays look natural with a high contrast ratio, just like printed paper, thus offering a comfortable viewing experience which is not subject to glare.

E-ink displays consume power only when they are updated, further reducing the relative power consumption. Since e-ink requires such low power, it can be fed by means other than the power supply such as photoelectric cells placed on strategic locations which convert ambient light to power; making it all the more environmentally friendly. Displays incorporating E-ink can be easily read in direct sunlight or under any ambient light, with no glare. In dark areas, light sources can be used to facilitate reading.

E-ink displays do not need power to stay on. Indeed, when power supply is cut, E-ink displays retain the last image almost indefinitely. With some software manipulation important information such as machine copy logs, the amount of toner left, amount of ink, jam status, etc. will be visible even after the power supply has been turned off. This will ensure that the next user is aware of the problems without even turning on the machine (and then waiting for the relevant prompt on the GUI) and can thus rectify them, thereby improving productivity.

Liquid crystal displays tend to be bulkier, weightier and a lot more delicate than their E-ink counterparts. It goes without saying that the level of complexity in changing LCD's is significantly more than that of E-ink displays which just have a single connector and the whole sheet can be easily replaced. Also, E-ink displays tend to be flexible and can be shaped around a curve. They are more durable than LCDs as well. Just like LCDs, E-ink displays allow touch screen interaction.

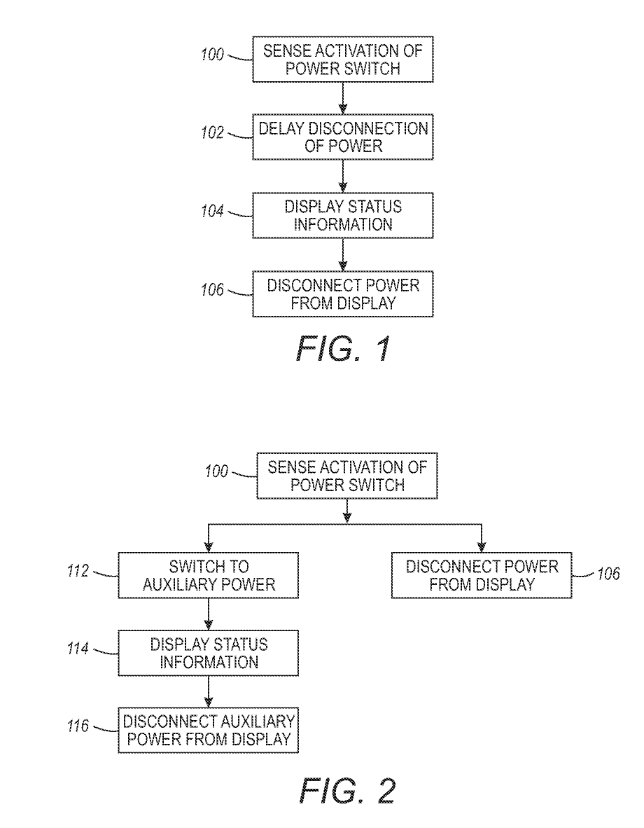

FIG. 1 is flowchart illustrating an exemplary method herein. In item 100, this method senses activation of a power switch (or other similar user input) of a printing apparatus that controls whether a power supply is connected to and supplies power to a processor, a printing engine, and a graphic user interface of the printing apparatus.

In item 102, this method automatically delays (using the processor) disconnection of the power supply from the graphic user interface until status information can be displayed on the graphic user interface. Then, in item 104, this method causes (again, using the processor) the graphic user interface to display status information of the printing apparatus. More specifically, item 104 occurs immediately prior to the switch being allowed to disconnect the power supply from the graphic user interface.

Then, in item 106, after the graphic user interface displays the status information of the printing apparatus in item 104, the processor allows the action of the switch to disconnect the power supply from the graphic user interface. The graphic user interface comprises a bistable display that continues to show the most recently provided screenshot, even after the switch disconnects the power supply from the graphic user interface. Therefore, after item 106, the graphic user interface displays the status information after being disconnected from the power supply.

FIG. 2 is a flowchart that illustrates an alternative method herein. This flow again begins in item 100 by again sensing activation of the power switch. Upon activation of the power switch, the power is immediately disconnected from the display (again in item 106). However, in this embodiment, simultaneously with disconnection of the power supply, in item 112, an auxiliary power supply (such as a battery, solar cell, back-EMF voltage from electric actuators, etc.) is connected to the processor and the graphic user display.

Then, as before (in item 114) this method causes (again, using the processor) the graphic user interface to display status information of the printing apparatus. Then, in item 116, after the graphic user interface displays the status information of the printing apparatus in item 114, the processor disconnects the auxiliary power supply from the graphic user interface. After item 116, the graphic user interface displays the status information after being disconnected from the power supply.

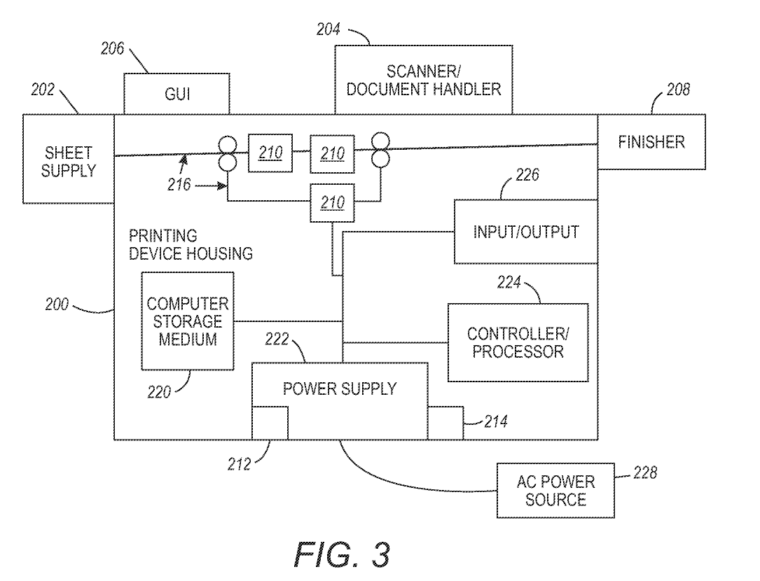

FIG. 3 illustrates a computerized printing device 200, which can be used with embodiments herein and can comprise, for example, a printer, copier, multi-function printing device, facsimile machine, stand-alone scanner, etc. (which is often referred to herein simply as an MFD 200). The MFD 200 includes a controller/processor 224, at least one marking device (printing engines) 210 operatively connected to the processor 224, a media path 216 positioned to supply sheets of media from a sheet supply 202 to the marking device(s) 210, and a communications port (input/output) 226 operatively connected to the processor 224 and to a computerized network external to the printing device. After receiving various markings from the printing engine(s), the sheets of media can optionally pass to a finisher 208 which can fold, staple, sort, etc., the various printed sheets.

The input/output device 226 is used for communications to and from the multi-function MFD 200. The processor 224 controls the various actions of the printing device. A non-transitory computer storage medium device 220 (which can be optical, magnetic, capacitor based, etc.) is readable by the processor 224 and stores instructions that the processor 224 executes to allow the multi-function printing device to perform its various functions, such as those described herein.

Thus, a printer body housing 200 has one or more functional components that operate on power supplied from the alternating current (AC) 228 by the power supply 222. The power supply 222 connects to an external alternating current power source 228 and converts the external power into the type of power needed by the various components.

Also, the MFD 200 can include at least one accessory functional component (such as a scanner/document handler 204, sheet supply 202, finisher 208, etc.) and graphic user interface assembly 206 that also operate on the power supplied from the external power source 228 (through the power supply 222).

Therefore, as shown, at least one power supply 222 is operatively connected to (directly or indirectly connected to) at least the processor 224, the printing engine 210, and the graphic user interface 206. Further, the power supply 222 includes a switch 212 that controls whether the power supply 222 is connected to and supplies power to the processor 224, the printing engine, and the graphic user interface 206.

The graphic user interface 206 comprises a bistable display 206 that continues to show the most recently provided screenshot, even after the switch 212 disconnects the power supply 222 from the graphic user interface 206. The bistable display 206 can be, for example, an electrophoretic display, a bichromal balls display, etc.

As mentioned above, the processor 224 controls responses to user input to the power switch 212, and the processor 224 causes the graphic user interface 206 to display status information of the printing apparatus immediately prior to disconnecting the power supply 222 from the graphic user interface 206 in response to the user input to the switch 212, such that the graphic user interface 206 displays the status information after being disconnected from the power supply 222. Thus, the processor 224 delays disconnection of the power supply 222 from the graphic user interface 206 until the status information is displayed on the graphic user interface 206.

Alternatively, instead of delaying disconnection of the power supply 222, the processor 224 can engage an auxiliary power supply 214 (such as a battery, solar cell, etc.) to cause the graphic user interface 206 to display status information of the printing apparatus immediately after the switch 212 disconnects the power supply 222 from the graphic user interface 206, such that the graphic user interface 206 will display the status information after being disconnected from the power supply 222. Afterword, the processor 224 disengages the auxiliary power supply 214 once the graphic user interface 206 displays the status information. The status information comprises, for example, consumable supply levels, printer operational status, warning messages, etc.

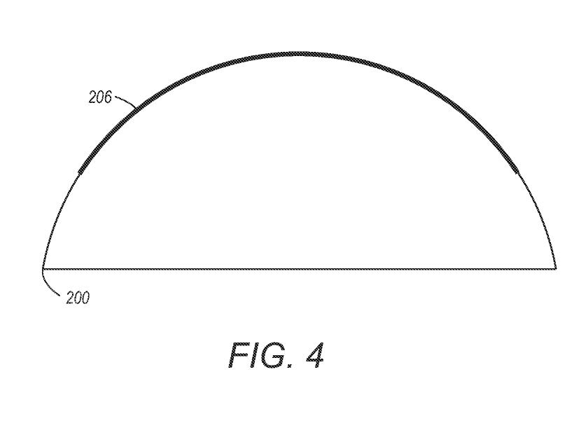

In addition, the body 200 of the printing apparatus surrounds the processor 224, the printing engine, and power supply 222. As shown in cross-section in FIG. 4, at least a portion of the body 200 may have at least one curved section, and the graphic user interface 206 comprises a curved graphic user interface 206 that conforms to the shape of the curved section of the body 200.

As would be understood by those ordinarily skilled in the art, the MFD 200 shown in FIG. 3 is only one example and the embodiments herein are equally applicable to other types of scanning devices that may include fewer components or more components. For example, while a limited number of printing engines and paper paths are illustrated in FIG. 3, those ordinarily skilled in the art would understand that many more paper paths and additional printing engines could be included within any printing device used with embodiments herein.

Thus, the embodiments herein consume a fraction of the power compared to liquid crystal displays, only require power when the display is updated, and do not require power to stay on (E-ink displays can retain the last image almost indefinitely). The high contrast ratio of bistable displays means the embodiments herein are easy on the eyes. Further, the power can be sourced by alternative renewable sources, the bistable displays are more flexible, durable, and lighter than LCDs, and such displays facilitate touch screen interaction so the existing level of functionality with LCD's is not compromised.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A printing apparatus comprising:
at least one processor;
at least one printing engine operatively connected to said processor;
at least one graphic user interface operatively connected to said processor; and
at least one power supply connected to said processor, said printing engine, and said graphic user interface,
said power supply comprising a switch that controls whether said power supply is connected to and supplies power to said processor, said printing engine, and said graphic user interface,
said graphic user interface comprising a bistable display that continues to show a most recently provided screenshot after said switch disconnects said power supply from said graphic user interface, and
said processor causing said graphic user interface to display status information of said printing apparatus immediately prior to said switch being allowed to disconnect said power supply from said graphic user interface, such that said graphic user interface displays said status information after being disconnected from said power supply.

2. The printing apparatus according to claim 1, said processor delaying disconnection of said power supply from said graphic user interface until said status information is displayed on said graphic user interface.

3. The printing apparatus according to claim 1, said status information comprising at least one of consumable supply levels, printer operational status, and warning messages.

4. The printing apparatus according to claim 1, further comprising a body surrounding said processor, said printing engine, and power supply; said body comprising at least one curved section, said graphic user interface comprising a curved graphic user interface conforming to a shape of said curved section of said body.

5. The printing apparatus according to claim 1, said bistable display comprising one of an electrophoretic display, an E-ink display, and a bichromal balls display.

6. A printing apparatus comprising:
at least one processor;
at least one printing engine operatively connected to said processor;
at least one graphic user interface operatively connected to said processor;
at least one main power supply connected to said processor, said printing engine, and said graphic user interface, said power supply comprising a switch that controls whether said power supply is connected to and supplies power to said processor, said printing engine, and said graphic user interface; and
an auxiliary power supply connected to said processor and said graphic user interface,
said graphic user interface comprising a bistable display that continues to show a most recently provided screenshot after said switch disconnects said power supply from said graphic user interface,
said processor engaging said auxiliary power supply to cause said graphic user interface to display status information of said printing apparatus immediately after said switch disconnects said power supply from said graphic user interface such that said graphic user interface, displays said status information after being disconnected from said power supply, and
said processor disengaging said auxiliary power supply once said graphic user interface to displays said status information.

7. The printing apparatus according to claim 6, said auxiliary power supply comprising one of a battery, and a solar power supply.

8. The printing apparatus according to claim 6, said status information comprising at least one of consumable supply levels, printer operational status, and warning messages.

9. The printing apparatus according to claim 6, further comprising a body surrounding said processor, said printing engine, and power supply; said body comprising at least one curved section, said graphic user interface comprising a curved graphic user interface conforming to a shape of said curved section of said body.

10. The printing apparatus according to claim 6, said bistable display comprising one of an electrophoretic display, an E-ink display, and a bichromal balls display.

11. A printing apparatus comprising:
at least one processor;
at least one printing engine operatively connected to said processor;
at least one graphic user interface operatively connected to said processor; and
at least one power supply connected to said processor, said printing engine, and said graphic user interface,
said power supply comprising a switch that controls whether said power supply is connected to and supplies power to said processor, said printing engine, and said graphic user interface,
said graphic user interface comprising a bistable display that continues to show a most recently provided screenshot after said switch disconnects said power supply from said graphic user interface,
said processor controlling responses to user input to said switch, and
said processor causing said graphic user interface to display status information of said printing apparatus immediately prior to disconnecting said power supply from said graphic user interface in response to said user input to said switch, such that said graphic user interface displays said status information after being disconnected from said power supply.

12. The printing apparatus according to claim 11, said processor delaying disconnection of said power supply from said graphic user interface until said status information is displayed on said graphic user interface.

13. The printing apparatus according to claim 11, said status information comprising at least one of consumable supply levels, printer operational status, and warning messages.

14. The printing apparatus according to claim 11, further comprising a body surrounding said processor, said printing engine, and power supply; said body comprising at least one curved section, said graphic user interface comprising a curved graphic user interface conforming to a shape of said curved section of said body.

15. The printing apparatus according to claim 11, said bistable display comprising one of an electrophoretic display, an E-ink display, and a bichromal balls display.

16. A method comprising:
sensing activation a switch of a printing apparatus that controls whether a power supply is connected to and supplies power to a processor, a printing engine, and a graphic user interface of said printing apparatus, said graphic user interface comprising a bistable display that continues to show a most recently provided screenshot after said switch disconnects said power supply from said graphic user interface, and
causing, using said processor, said graphic user interface to display status information of said printing apparatus immediately prior to said switch being allowed to disconnect said power supply from said graphic user interface such that said graphic user interface displays said status information after being disconnected from said power supply.

17. The method according to claim 16, further comprising delaying, using said processor, disconnection of said power supply from said graphic user interface until said status information is displayed on said graphic user interface.

18. The method according to claim 16, said status information comprising at least one of consumable supply levels, printer operational status, and warning messages.

19. The method according to claim 16, said printing apparatus comprising a body surrounding said processor, said printing engine, and power supply; said body comprising at least one curved section, said graphic user interface comprising a curved graphic user interface conforming to a shape of said curved section of said body.

20. The method according to claim 16, said bistable display comprising one of an electrophoretic display, an E-ink display, and a bichromal balls display.
